(19) United States
(12) Patent Application Publication
(10) Pub. No.: US 2016/0019061 A1
(43) Pub. Date: Jan. 21, 2016

(54) MANAGING DATAFLOW EXECUTION OF LOOP INSTRUCTIONS BY OUT-OF-ORDER PROCESSORS (OOPs), AND RELATED CIRCUITS, METHODS, AND COMPUTER-READABLE MEDIA

(71) Applicant: QUALCOMM Incorporated, San Diego, CA (US)

(72) Inventors: Karamvir Singh Chatha, San Diego, CA (US); Michael Alexander Howard, Cardiff, CA (US); Rick Seokyong Oh, San Diego, CA (US); Ramesh Chandra Chauhan, San Diego, CA (US)

(21) Appl. No.: 14/485,899

(22) Filed: Sep. 15, 2014

Related U.S. Application Data
(60) Provisional application No. 62/026,752, filed on Jul. 21, 2014.

(51) Int. Cl. G06F 9/30

(52) U.S. Cl. CPC G06F 9/30065; G06F 9/30145

(57) ABSTRACT

Managing dataflow execution of loop instructions by out-of-order processors (OOPs), and related circuits, methods, and computer-readable media are disclosed. In one aspect, a reservation station circuit is provided. The reservation station circuit includes multiple reservation station segments, each storing a loop instruction of a loop of a computer program. Each reservation station segment also stores an instruction execution credit indicating whether the corresponding loop instruction may be provided for dataflow execution. The reservation station circuit further includes a dataflow monitor that distributes an initial instruction execution credit to each reservation station segment. As each loop iteration is executed, each reservation station segment determines whether the instruction execution credit indicates that the loop instruction for the reservation station segment may be provided for dataflow execution. If so, the reservation station segment provides the loop instruction for dataflow execution, and adjusts the instruction execution credit for the reservation station segment.

### PRIORITY CLAIM

The present application claims priority to U.S. Provisional Patent Application Ser. No. 62/026,752 filed on Jul. 21, 2014 and entitled “MANAGING DATAFLOW EXECUTION OF LOOP INSTRUCTIONS BY OUT-OF-ORDER PROCESSORS (OOPs), AND RELATED CIRCUITS, METHODS, AND COMPUTER-READABLE MEDIA,” which is incorporated herein by reference in its entirety.

### BACKGROUND

I. Field of the Disclosure

The technology of the disclosure relates generally to dataflow execution of loop instructions by out-of-order processors (OOPs).

II. Background

Many modem processors are out-of-order processors (OOPs) that are capable of dataflow execution of program instructions. Using a dataflow execution approach, the execution order of program instructions by an OOP may be determined by the availability of input data for each program instruction (“dataflow order”), rather than the program order of the program instruction. Thus, the OOP may execute the program instruction as soon as all input data for the program instruction has been generated. While this may cause the specific order in which program instructions are executed to be unpredictable, the OOP may realize performance gains using dataflow execution of program instructions. For example, instead of having to “stall” (i.e., intentionally introduce a processing delay) while input data is retrieved for an older program instruction, the OOP may proceed with executing a more recently fetched instruction that is able to execute immediately. In this manner, processor clock cycles that would otherwise be wasted may be productively utilized by the OOP.

A conventional OOP may employ an instruction window, which designates a set of program instructions that may be executed out of order. When execution of a program instruction within the instruction window is complete, the results of the execution may be “committed,” or made non-speculative, and the program instruction may be retired from the instruction window to make room for a new program instruction for execution. However, in some circumstances, the eviction of program instructions from the instruction window may result in inefficient operation of the OOP. For example, if the program instructions are part of a loop, the same program instructions may be executed repeatedly over multiple loop iterations. Consequently, the program instructions may be fetched, executed, and retired again and again from the instruction window as the loop executes.

Performance of an OOP in the circumstances described above may be improved through the use of reservation station segments. A reservation station segment is an OOP microarchitecture feature that may store a program instruction along with related information required for execution, such as operands. The OOP may load each program instruction associated with a loop into a corresponding reservation station segment. Each reservation station segment may be configured to hold a program instruction for a specified number of loop iterations, rather than retiring the program instruction before the loop has completed. When a reservation station segment determines that all input data for its program instruction is available, the reservation station segment provides the program instruction and its input data to a processor for execution. Only after the loop has completed all iterations are the program instructions associated with the loop retired from the corresponding reservation station segments.

One issue that arises with the use of reservation station segments is managing the production of input data for program instructions with respect to consumption of the input data. If a rate at which a producer instruction generates data is greater than a rate at which a consumer instruction can utilize the data as input, the data may be lost, or the use of a storage solution that is expensive in terms of processor cycles and/or power may be required.

### SUMMARY OF THE DISCLOSURE

Aspects disclosed in the detailed description include managing dataflow execution of loop instructions by out-of-order processors (OOPs). Related circuits, methods, and computer-readable media are also disclosed. In this regard in one aspect, a reservation station circuit for managing dataflow execution of loop instructions is provided. The reservation station circuit includes multiple reservation station segments, each of which stores a loop instruction of a loop of a computer program. Each reservation station segment also stores an instruction execution credit, which indicates whether the loop instruction may be provided for dataflow execution. The reservation station circuit further includes a dataflow monitor. Before execution of the loop begins, the dataflow monitor distributes an initial instruction execution credit to each reservation station segment. As an iteration of the loop is executed, each reservation station segment determines whether the instruction execution credit for the reservation station segment indicates that the loop instruction may be provided for dataflow execution. If so, the reservation station segment provides the loop instruction of the reservation station segment for dataflow execution. The reservation station segment may then adjust the instruction execution credit of an instruction execution credit indicator for the reservation station segment.

In another aspect, a reservation station circuit for managing dataflow execution of loop instructions in an OOP is provided. The reservation station circuit comprises a plurality of reservation station segments. Each reservation station segment comprises a loop instruction register configured to store a loop instruction of a loop. Each reservation station segment also comprises an instruction execution credit indicator configured to store an instruction execution credit indicating whether the loop instruction may be provided for dataflow execution. The reservation station circuit further comprises a dataflow monitor configured to distribute an initial instruction execution credit to the instruction execution credit indicator of each reservation station segment of the plurality of reservation station segments. Each reservation station segment of the plurality of reservation station segments is configured to repeatedly determine whether the instruction execution credit of the instruction execution credit indicator for the reservation station segment indicates that the loop instruction may be provided for dataflow execution. Each reservation station segment is further configured to, responsive to determining that the instruction execution credit indicates that the loop instruction may be provided for dataflow execution, provide the loop instruction of the reservation station segment for dataflow execution. Each reservation station segment is also configured to, responsive to determining that the instruction execution credit indicates that the loop instruction may be provided for dataflow execution, adjust the instruction execution credit of the instruction execution credit indicator for the reservation station segment.

In another aspect, a method for managing dataflow execution of loop instructions in an OOP is provided. The method comprises distributing, by a dataflow monitor, an initial instruction execution credit to each reservation station segment of a plurality of reservation station segments, each reservation station segment storing a loop instruction of a loop and an instruction execution credit indicator. The method further comprises, for each reservation station segment of the plurality of reservation station segments, repeatedly determining whether an instruction execution credit for the reservation station segment indicates that the loop instruction may be provided for dataflow execution. The method also comprises, responsive to determining that the instruction execution credit indicates that the loop instruction may be provided for dataflow execution, providing the loop instruction of the reservation station segment for dataflow execution. The method additionally comprises, further responsive to determining that the instruction execution credit indicates that the loop instruction may be provided for dataflow execution, adjusting the instruction execution credit of the reservation station segment.

In another aspect, a non-transitory computer-readable medium having stored thereon computer-executable instructions to cause a processor to implement a method for managing dataflow execution of loop instructions in an OOP is provided. The method implemented by the computer-executable instructions comprises distributing, by a dataflow monitor, an initial instruction execution credit to each reservation station segment of a plurality of reservation station segments, each reservation station segment storing a loop instruction of a loop. The method implemented by the computer- executable instructions further comprises, for each reservation station segment of the plurality of reservation station segments, repeatedly determining whether an instruction execution credit for the reservation station segment indicates that the loop instruction may be provided for dataflow execution. The method implemented by the computer-executable instructions also comprises, responsive to determining that the instruction execution credit indicates that the loop instruction may be provided for dataflow execution, providing the loop instruction of the reservation station segment for dataflow execution. The method implemented by the computer-executable instructions additionally comprises, further responsive to determining that the instruction execution credit indicates that the loop instruction may be provided for dataflow execution, adjusting the instruction execution credit of the reservation station segment.

### BRIEF DESCRIPTION OF THE FIGURES

FIG. 1 is a block diagram illustrating an exemplary out-of-order processor (OOP) that includes a reservation station circuit managing dataflow execution of loop instructions;

FIG. 2 is a diagram illustrating an exemplary reservation station segment;

FIG. 3 is a block diagram illustrating multiple reservation station segments and the data dependencies between each reservation station segment;

FIG. 4 is a chart illustrating instruction execution credits for each reservation station segment of FIG. 3 during loop execution, where each reservation station segment is issued two instruction execution credits at the beginning of the loop;

FIGS. 5A-5B are flowcharts illustrating exemplary operations for managing dataflow execution of loop instructions in the exemplary OOP of FIG. 1;

FIG. 6 is a flowchart illustrating additional exemplary operations for managing dataflow execution of loop instructions using a counter-based instruction execution credit indicator in the exemplary OOP of FIG. 1; and

FIG. 7 is a block diagram of an exemplary processor-based system that can include the reservation station circuit of FIG. 1.

### DETAILED DESCRIPTION

With reference now to the drawing figures, several exemplary aspects of the present disclosure are described. The word “exemplary” is used herein to mean “serving as an example, instance, or illustration.” Any aspect described herein as “exemplary” is not necessarily to be construed as preferred or advantageous over other aspects.

Aspects disclosed in the detailed description include managing dataflow execution of loop instructions by out-of-order processors (OOPs). Related circuits, methods, and computer-readable media are also disclosed. In this regard in one aspect, a reservation station circuit for managing dataflow execution of loop instructions is provided. The reservation station circuit includes multiple reservation station segments, each of which stores a loop instruction of a loop of a computer program. Each reservation station segment also stores an instruction execution credit, which indicates whether the loop instruction may be provided for dataflow execution. The reservation station circuit further includes a dataflow monitor. Before execution of the loop begins, the dataflow monitor distributes an initial instruction execution credit to each reservation station segment. As an iteration of the loop is executed, each reservation station segment determines whether the instruction execution credit for the reservation station segment indicates that the loop instruction may be provided for dataflow execution. If so, the reservation station segment provides the loop instruction of the reservation station segment for dataflow execution. The reservation station segment may then adjust the instruction execution credit of an instruction execution credit indicator for the reservation station segment.

In another aspect, a reservation station circuit for managing dataflow execution of loop instructions in an OOP is provided. The reservation station circuit comprises a plurality of reservation station segments. Each reservation station segment comprises a loop instruction register configured to store a loop instruction of a loop. Each reservation station segment also comprises an instruction execution credit indicator configured to store an instruction execution credit indicating whether the loop instruction may be provided for dataflow execution. The reservation station circuit further comprises a dataflow monitor configured to distribute an initial instruction execution credit to the instruction execution credit indicator of each reservation station segment of the plurality of reservation station segments. Each reservation station segment of the plurality of reservation station segments is configured to repeatedly determine whether the instruction execution credit of the instruction execution credit indicator for the reservation station segment indicates that the loop instruction may be provided for dataflow execution. Each reservation station segment is further configured to, responsive to determining that the instruction execution credit indicates that the loop instruction may be provided for dataflow execution, provide the loop instruction of the reservation station segment for dataflow execution. Each reservation station segment is also configured to, responsive to determining that the instruction execution credit indicates that the loop instruction may be provided for dataflow execution, adjust the instruction execution credit of the instruction execution credit indicator for the reservation station segment.

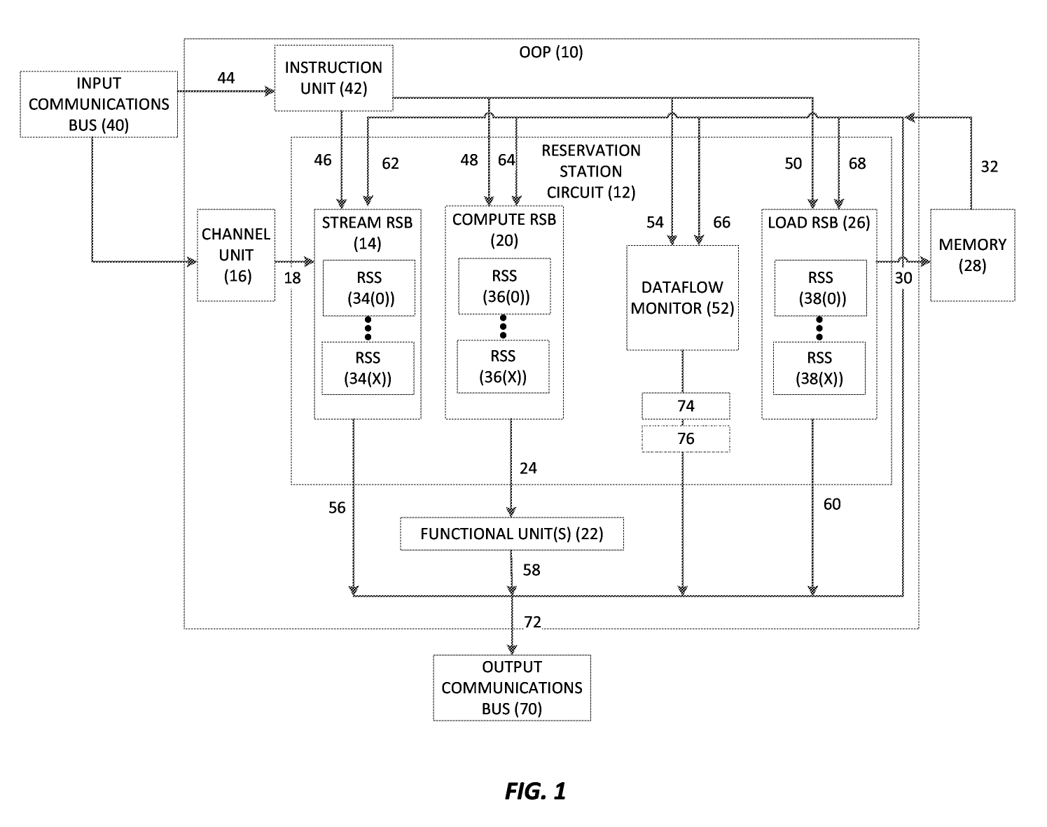

In this regard, FIG. 1 is a block diagram of an OOP 10 configured to provide out-of-order dataflow execution of program instructions. In particular, the OOP 10 includes a reservation station circuit 12 for managing dataflow execution of loop instructions. The OOP 10 may encompass any one of known digital logic elements, semiconductor circuits, processing cores, and/or memory structures, among other elements, or combinations thereof. Aspects described herein are not restricted to any particular arrangement of elements, and the disclosed techniques may be easily extended to various structures and layouts on semiconductor dies or packages. While FIG. 1 illustrates a single OOP 10, it is to be understood that some aspects may provide multiple, communicatively coupled OOPs 10.

In some environments, an application program may be conceptualized as a “pipeline” of kernels (i.e., specific areas of functionality), wherein each kernel operates on a stream of data tokens passing through the pipeline. The OOP 10 of FIG. 1 may embody a programmable core for implementing the functionality of one or more kernels, and for applying that functionality repeatedly to different sets of data streamed to the OOP 10. To provide kernel functionality in an energy efficient manner, the OOP 10 may provide a feature referred to herein as “instruction re-vitalization.” Instruction re-vitalization enables a set of program instructions to be loaded once together into the OOP 10, and to be subsequently executed multiple times without being retired or evicted from the OOP 10. In this manner, the OOP 10 may execute the set of instructions iteratively on successive data items streamed into the OOP 10. Instruction re-vitalization may thus reduce energy consumption and improve processor performance of the OOP 10 by eliminating the need for a multi-stage execution pipeline. Due to the iterative nature of programming constructs such as loops, instruction re-vitalization may make the OOP 10 especially suited for processing kernels comprising loop instructions.

The OOP 10 is organized into one or more reservation station blocks (also referred to herein as “RSBs”), each of which may correspond to a general type of program instruction. For example, a stream RSB 14 may handle instructions for receiving data streams via a channel unit 16, as indicated by arrow 18. A compute RSB 20 may handle instructions that access one or more functional units 22 (e.g., an arithmetic logic unit (ALU) and/or a floating point unit) for carrying out computational operations, as indicated by arrow 24. Results produced by instructions in the compute RSB 20 may be consumed as input by other instructions in the compute RSB 20. A load RSB 26 handles instructions for loading data from and outputting data to a data store, such as a memory 28, as indicated by arrows 30 and 32. It is to be understood that the OOP 10 may be organized into more than one of each of the stream RSB 14, the compute RSB 20, and/or the load RSB 26. The stream RSB 14, the compute RSB 20, and the load RSB 26 include one or more reservation station segments (also referred to herein as “RSSs”) 34(0-X), 36(0-X), and 38(0-X), respectively. Each of the reservation station segments 34, 36, 38 stores a single instruction, along with associated data required for dataflow execution of the resident instruction.

In typical operation, an input communications bus 40 communicates instructions for the kernel to be executed by the OOP 10 to an instruction unit 42 of the OOP 10, as indicated by arrow 44. The instruction unit 42 then loads the instructions into the one or more reservation station segments 34 of the stream RSB 14 (as indicated by arrow 46), the one or more reservation segments 36 of the compute RSB 20 (as indicated by arrow 48), and/or the one or more reservation station segments 38 of the load RSB 26 (as indicated by arrow 50), based on the instruction type. A dataflow monitor 52 may also receive initialization data, such as a number of loop iterations to execute, as indicated by arrow 54.

The OOP 10 may then execute the resident instructions of the reservation station segments 34, 36, and/or 38 in any appropriate order. As a non-limiting example, the OOP 10 may execute the resident instructions of the reservation station segments 34, 36, and/or 38 in a dataflow execution order. The result (if any) produced by execution of each resident instruction and an identifier for the resident instruction are broadcast by the reservation station segments 34, 36, and 38, as indicated by arrows 56, 58, and 60, respectively. The reservation station segments 34, 36, and 38 and the dataflow monitor 52 then receive the broadcast data as input streams (as indicated by arrows 62, 64, 66, and 68, respectively). The reservation station segments 34, 36, and 38 may monitor the respective input streams indicated by arrows 62, 64, and 68 to identify results from previously executed instructions that are required as input operands (not shown). Once detected, the input operands may be stored, and after all required operands are received, the resident instruction associated with the reservation station segment 34, 36, and/or 38 may be provided for dataflow execution. Loop instructions for a loop may thus be iteratively executed in a dataflow manner until the dataflow monitor 52 detects that all iterations of the loop have completed. Data may be streamed out of the OOP 10 to an output communications bus 70, as indicated by arrow 72.

One issue that may arise with the OOP 10 of FIG. 1 is management of the production of input data for instructions with respect to consumption of the input data. If producer instructions generate data at a rate exceeding that at which consumer instruction can utilize the data as input, the data may be lost. This issue may be mitigated through the use of intermediate storage for input data, but intermediate storage solutions may be expensive in terms of processor cycles and/or energy consumption.

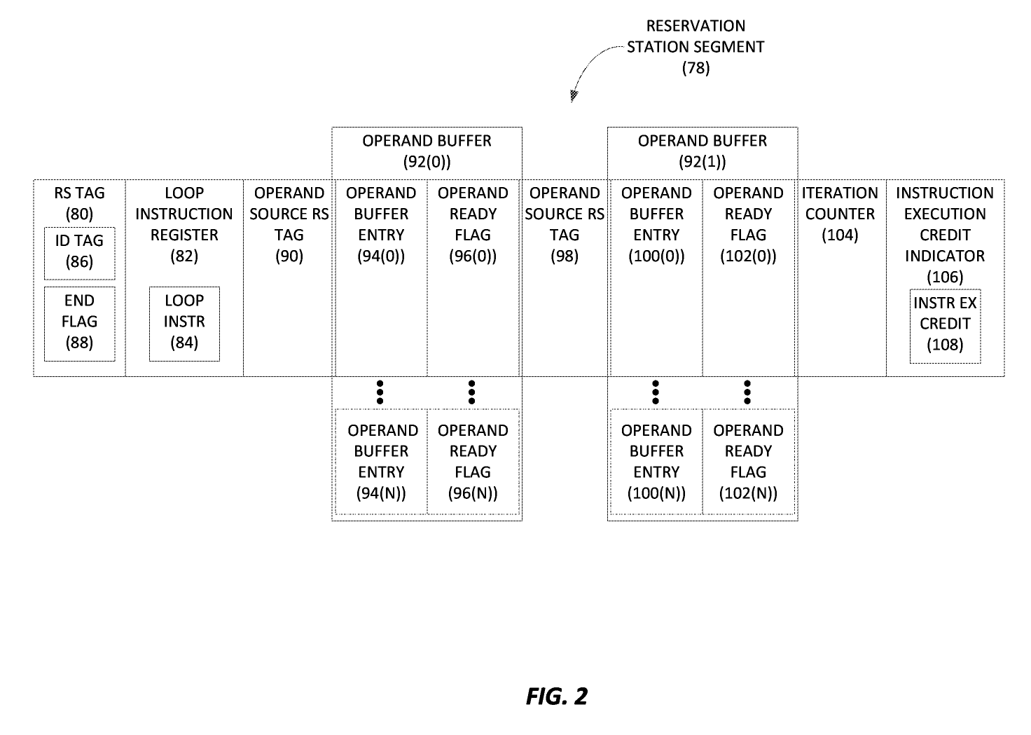

In this regard, the reservation station circuit 12 of FIG. 1 is provided. The dataflow monitor 52 and the reservation station segments 34, 36, and 38 of the reservation station circuit 12 coordinate to provide a credit-based system that determines when each instruction is allowed to execute. Each of the reservation station segments 34, 36, and 38 is associated with an instruction execution credit indicator, discussed in greater detail below with respect to FIG. 2. In some aspects, each instruction execution credit indicator may comprise a counter, and/or may be a flag and/or other state indicator. As part of initialization of the kernel to be executed by the OOP 10, the dataflow monitor 52 distributes an initial instruction execution credit 74 to each of the reservation station segments 34, 36, and 38. Each of the reservation station segments 34, 36, and 38 then makes execution of its associated resident instruction contingent on the associated instruction execution credit indicator. The associated resident instructions thus may be provided for execution by the reservation station segments 34, 36, and 38 only if indicated by the corresponding instruction execution credit indicator. In some aspects in which the instruction execution credit indicator is a counter, the associated resident instruction may be provided for execution only if a value of the instruction execution credit indicator is greater than zero. As each loop iteration completes, the dataflow monitor 52 may distribute an additional instruction execution credit 76. In this manner, a producer instruction may be prevented from executing until a consumer instruction is able to “catch up” by consuming the produced input data.

Aspects of the dataflow monitor 52, the stream RSB 14, the compute RSB 20, and/or the load RSB 26 may employ different techniques for detecting the completion of a loop iteration. In some aspects, an RSB (i.e., one of the stream RSB 14, the compute RSB 20, and the load RSB 26) may maintain a count of instructions that have executed during a loop iteration I. When the count of instructions executed for the loop iteration I becomes equal to a number of instructions in the RSB, the RSB communicates an end loop iteration I status (not shown) to the dataflow monitor 52. Once the dataflow monitor 52 has received an end loop iteration I status from all RSBs, the dataflow monitor 52 knows that all instructions for the loop iteration I have finished execution. The dataflow monitor 52 may then issue an additional instruction execution credit 76.

Some aspects may provide that each reservation station segment 34, 36, and 38 includes an end bit (not shown) that signifies whether each resident instruction is a “leaf” instruction in a dataflow ordering of the instructions (i.e., an instruction on which there are no data dependencies). When all end flag instructions have executed, a loop iteration has completed. Accordingly, each resident instruction broadcasts its end flag upon execution. The dataflow monitor 52 maintains a count of the number of end flag instruction executions for a particular loop iteration I, and the total number of end flag instructions within the loop iteration I. Once the number of end flag instruction executions for the loop iteration I becomes equal to the total number of end flag instructions, the dataflow monitor 52 may conclude that all instructions for the loop iteration I have completed execution. The dataflow monitor 52 may then issue an additional instruction execution credit 76.

FIG. 2 is a diagram illustrating elements of an exemplary reservation station segment 78, such as one of the reservation station segments 34, 36, 38 of FIG. 1. It is to be understood that the elements shown in FIG. 2 are for illustrative purposes only, and that some aspects of the reservation station segments 34, 36, and/or 38 of FIG. 1 may include more or fewer elements than shown in FIG. 2.

The reservation station segment 78 of FIG. 2 includes a reservation station (RS) tag 80, which serves as a unique identifier for the reservation station segment 78. The reservation station segment 78 also includes a loop instruction register 82, which stores a loop instruction 84 associated with the reservation station segment 78. As a non-limiting example, the loop instruction 84 may be an instruction opcode. In the example of FIG. 2, the RS tag 80 includes a 7-bit identifier (ID) tag 86 and a 1-bit end flag 88. When set, the end flag 88 indicates that the loop instruction 84 associated with the reservation station segment 78 is a “leaf” instruction. By detecting the set end flag 88 within the RS tag 80 of the loop instruction 84 that has executed, the dataflow monitor 52 of FIG. 1 may determine that a loop iteration has completed. In some aspects, a loop iteration may include more than one leaf instruction. Accordingly, the dataflow monitor 52 may be configured to track a count of leaf instructions executed within a loop iteration. It is to be understood that other aspects of the reservation station segment 78 may employ other techniques for determining that a loop iteration has completed. As a non-limiting example, an RSB of which the reservation station segment 78 is a part may maintain a count of instructions that have executed during each loop iteration.

The reservation station segment 78 also provides storage for data that may be required by the loop instruction 84 to execute. In the example of FIG. 2, the loop instruction 84 is associated with a first operand and a second operand. Accordingly, to store data associated with the first operand, the reservation station segment 78 provides an operand source RS tag 90 and an operand buffer 92(0). The operand source RS tag 90 may identify a reservation station segment (not shown) that is associated with an instruction (not shown) that generates the first operand. The operand buffer 92(0) includes one or more operand buffer entries 94(0)-94(N) and a corresponding one or more operand ready flags 96(0)-96(N). Each of the operand buffer entries 94(0)-94(N) may store an operand value generated during a corresponding loop iteration 0-N (not shown), while each operand ready flag 96(0)-96(N) may indicate when the associated operand buffer entry 94(0)-94(N) is ready for consumption by the loop instruction 84.

Similarly, to store data associated with the second operand, the reservation station segment 78 provides an operand source RS tag 98 and an operand buffer 92(1). The operand buffer 92(1) includes one or more operand buffer entries 100(0)-100(N), and a corresponding one or more operand ready flags 102(0)-102(N). The operand source RS tag 98, the operand buffer entries 100(0)-100(N), and the operand ready flags 102(0)-102(N) may function in a manner corresponding to the functionality of the operand source RS tag 90, the operand buffer entries 94(0)-94(N), and the operand ready flags 96(0)-96(N), respectively.

The reservation station segment 78 also includes an iteration counter 104. The iteration counter 104 may be set to an initial value of zero, and subsequently incremented with each execution of the loop instruction 84. A current value of the iteration counter 104 may be provided by the reservation station segment 78 when the loop instruction 84 is provided for dataflow execution. In this manner, the current value of the iteration counter 104 may be used by subsequently-executing consumer instructions to determine the loop iteration in which the loop instruction 84 executed.

The reservation station segment 78 additionally includes an instruction execution credit indicator 106, which stores an instruction execution credit 108 distributed to the reservation station segment 78 by the dataflow monitor 52. The reservation station segment 78 may be configured to provide the loop instruction 84 for execution only if the instruction execution credit indicator 106 indicates that the loop instruction 84 may be executed. For example, in some aspects, the instruction execution credit indicator 106 may comprise a counter, the value of which may be decremented after each execution of the loop instruction 84. The reservation station segment 78 may thus be configured to provide the loop instruction 84 for execution only if the instruction execution credit indicator 106 is currently storing a value greater than zero.

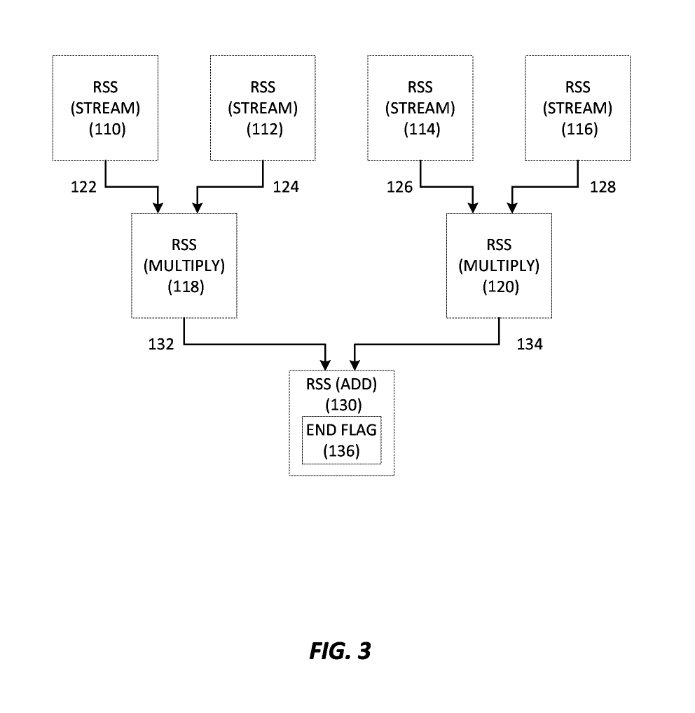

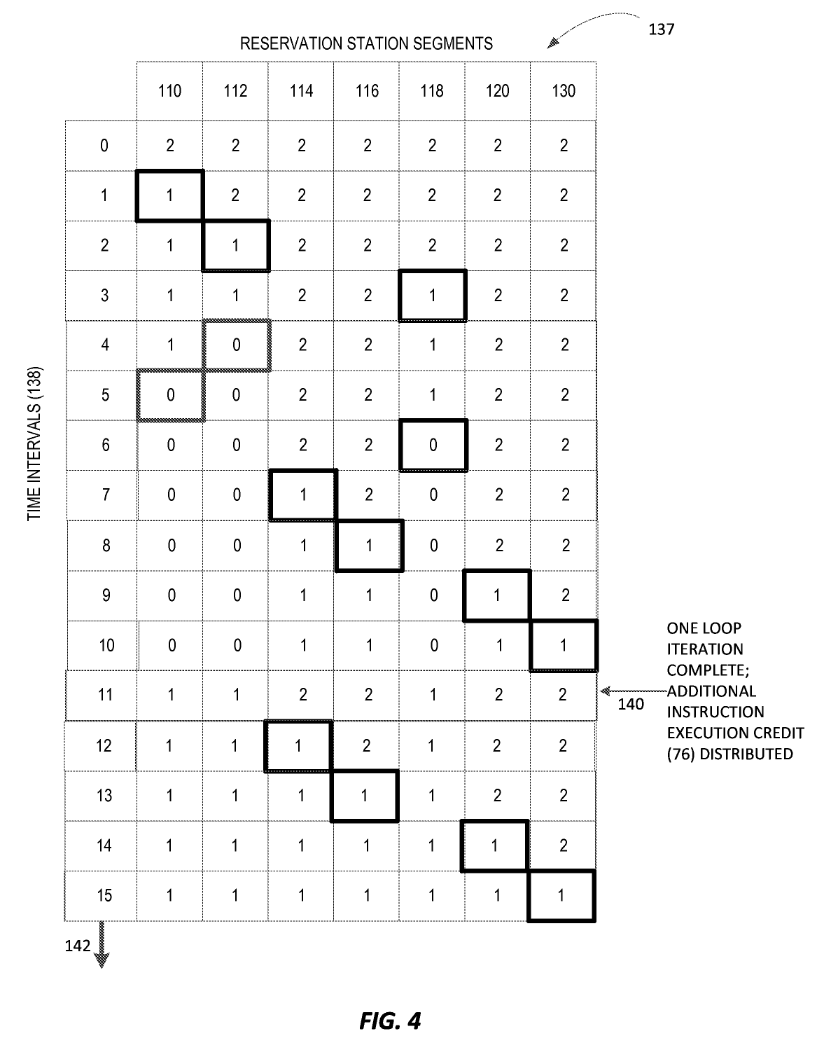

FIGS. 3 and 4 illustrate how exemplary reservation station segments executing instructions based on instruction execution credits, as implemented by the reservation station circuit 12 of FIG. 1, may provide management of dataflow execution of loop instructions. FIG. 3 shows reservation station segments and the data dependencies therebetween. FIG. 4 illustrates how instruction execution credits distributed to the reservation station segments of FIG. 3 may be used to govern dataflow execution of loop instructions during a loop iteration.

In FIG. 3, a total of seven reservation station segments (RSS) are illustrated. Each RSS 110, 112, 114, and 116 is associated with a resident stream instruction (not shown) that retrieves a data token (not shown) from a channel unit, such as the channel unit 16 of FIG. 1. For the sake of clarity, it is assumed that input for the resident stream instructions of each RSS 110, 112, 114, and 116 are always readily available from the channel unit 16. An RSS 118 and an RSS 120 are each associated with a multiply instruction (not shown) that computes a product of two operands. The RSS 118 receives, as operands, the data provided by the RSS 110 and the RSS 112, as indicated by arrows 122 and 124, respectively. Similarly, the RSS 120 receives, as operands, the data provided by the RSS 114 and the RSS 116, as indicated by arrows 126 and 128, respectively. A data dependency thus exists between the RSS 118 and each RSS 110 and 112, and between the RSS 120 and each RSS 114 and 116. An RSS 130 is associated with an add instruction (not shown) that computes a sum of two operands. The RSS 130 receives, as operands, the results generated by the RSS 118 and the RSS 120, as indicated by arrows 132 and 134, respectively.

In the example of FIG. 3, there are no instructions dependent on the result generated by the add instruction associated with the RSS 130. Accordingly, the RSS 130 includes an end flag 136 to indicate to the dataflow monitor 52 of FIG. 1 that execution of the add instruction of the RSS 130 represents the end of one loop iteration. In some aspects, the end flag 136 may comprise a one-bit indicator stored as part of an RS tag for the RSS 130, such as the end flag 88 of the RS tag 80 of FIG. 2.

To illustrate how the reservation station circuit 12 may utilize instruction execution credits distributed to each RSS 110, 112, 114, 116, 118, 120, 130 of FIG. 3 to manage dataflow execution of loop instructions, FIG. 4 is provided. FIG. 4 is a chart 137 of instruction execution credits, such as the instruction execution credit 108 of FIG. 2, as they vary over loop iterations. Each RSS 110, 112, 114, 116, 118, 120, and 130 of FIG. 3 is represented by a column of the chart, while the rows of the chart represent time intervals 138 during loop iterations. In FIG. 4, it is assumed that the instruction execution credit indicator, such as the instruction execution credit indicator 106 of FIG. 2, associated with each RSS 110, 112, 114, 116, 118, 120, and 130 is a counter. For the sake of clarity, elements of FIGS. 1, 2, and 3 are referenced in describing FIG. 4.

At time interval 0, the dataflow monitor 52 of the reservation station circuit 12 distributes an initial instruction execution credit, such as the initial instruction execution credit 74 of FIG. 1, to each RSS 110, 112, 114, 116, 118, 120, and 130. In this example, the initial instruction execution credit 74 has a value of 2, corresponding to a count of the operand buffer entries 94 and 100 of the operand buffers 92 of each RSS 110, 112, 114, 116, 118, 120, and 130. Execution of the loop instructions then commences.

Because input data for the resident stream instructions of the RSS 110, the RSS 112, the RSS 114, and the RSS 116 is readily available, the resident stream instructions effectively have no data dependencies. Therefore, the resident stream instructions associated with the RSS 110, the RSS 112, the RSS 114, and the RSS 116 are eligible for dataflow execution. In the example of FIG. 4, at time interval 1, the RSS 110 provides its resident stream instruction for execution. The RSS 110 then decrements its instruction execution credit 108 to 1. The result of the execution of the stream instruction associated with the RSS 110 will be broadcast to the other RSSs 112, 114, 116, 118, 120, and 130, and will be detected and stored by the RSS 118 in an operand buffer entry such as the operand buffer entry 94. In a similar manner, the RSS 112 provides its resident stream instruction for execution, and decrements its instruction execution credit 108 to 1 at time interval 2. The result of the execution of the stream instruction associated with the RSS 112 will be detected and stored as an operand by the RSS 118.

At time interval 3, both operands for the resident multiply instruction of the RSS 118 have been received, and thus the resident multiply instruction is eligible for dataflow execution. The resident stream instructions for the RSS 110, the RSS 112, the RSS 114, and the RSS 116 are also eligible for dataflow execution, having instruction execution credits 108 greater than zero and no effective data dependencies. In this example, the RSS 118 provides its resident multiply instruction to a functional unit, such as the functional unit 22 of FIG. 1, for execution. The RSS 118 then decrements its instruction execution credit 108 to 1. The result of the execution of the multiply instruction of the RSS 118 will be received by the RSS 130 as an operand. Note that at time interval 3, the data dependencies of the resident multiply instruction associated with the RSS 120 and the resident add instruction associated with the RSS 130 have not been satisfied, and thus those instructions are not eligible for dataflow execution.

At time interval 4, any of the resident stream instructions associated with the RSS 110, the RSS 112, the RSS 114, and the RSS 116 are eligible for dataflow execution. In the example of FIG. 4, the RSS 112 provides its resident stream instruction for execution, and decrements its instruction execution credit 108 to 0.

Similarly, at time interval 5, the RSS 110 provides its resident stream instruction to the functional unit 22 for execution, and decrements its instruction execution credit 108 to 0. The RSS 118, having received both operands needed to execute its resident multiply instruction, provides its resident multiply instruction to the functional unit 22 at time interval 6, and decrements its instruction execution credit 108 to 0.

At time interval 7, the instruction execution credits 108 associated with the RSS 110, the RSS 112, and the RSS 118 have all been decremented to 0. Accordingly, while input data may be available to the resident instructions of the RSS 110, the RSS 112, and the RSS 118, none of the resident instructions may be executed again until additional credits are distributed by the dataflow monitor 52. This allows the resident instructions of the RSS 114, the RSS 116, the RSS 120, and the RSS 130 to “catch up” by providing time to consume the data produced by the RSS 110, the RSS 112, and the RSS 118. Note also that, at time interval 7, the resident multiply instruction associated with the RSS 120 and the resident add instruction associated with the RSS 130 have unsatisfied data dependencies, and thus those instructions are not eligible for dataflow execution. Thus, the only instructions that may be executed at this point are the resident instructions of the RSS 114 and the RSS 116.

With continuing reference to FIG. 4, the RSS 114 at time interval 7 provides its resident stream instruction for execution, and decrements its instruction execution credit 108 to 1. At time interval 8, the RSS 116 provides its resident stream instruction to the functional unit 22 for execution, and decrements its instruction execution credit 108 to 1. As both operands required by the resident multiply instruction of the RSS 120 are now available, the RSS 120 at time interval 9 provides its resident multiply instruction to the functional unit 22 for execution, and decrements its instruction execution credit 108 to 1. Similarly, at time interval 10, both operands for the resident add instruction of the RSS 130 are now available. Thus, the RSS 130 provides its resident add instruction to the functional unit 22 for execution, and decrements its instruction execution credit 108 to 1.

Upon execution of the resident add instruction of the RSS 130, the dataflow monitor 52 may detect the end flag 136 of the RSS 130, and may determine that one iteration of the loop has completed. Accordingly, at time interval 11, the dataflow monitor 52 may distribute an additional instruction execution credit 76 to each of the RSS 110, the RSS 112, the RSS 114, the RSS 116, the RSS 118, the RSS 120, and the RSS 130, as indicated by arrow 140. In this example, distribution of the additional instruction execution credit 76 has the effect of incrementing the instruction execution credit 108 associated with each RSS 110, 112, 114, 116, 118, 120, and 130. Execution of loop instructions then continues.

Time intervals 12-15 proceed in a manner similar to that of time intervals 7-10. At time interval 12, the RSS 110, the RSS 112, the RSS 114, and the RSS 116 each have an instruction execution credit 108 greater than zero, and the resident stream instructions of the RSS 110, the RSS 112, the RSS 114, and the RSS 116 have no effective data dependencies. Accordingly, the resident stream instructions of the RSS 110, the RSS 112, the RSS 114, and the RSS 116 are all eligible for dataflow execution. In the example of FIG. 4, the RSS 114 provides its resident stream instruction for execution, and decrements its instruction execution credit 108 to 1. At time interval 13, the RSS 116 provides its resident stream instruction for execution, and decrements its instruction execution credit 108 to 1. As both operands required by the resident multiply instruction of the RSS 120 are now available, the RSS 120 at time interval 14 provides its resident multiply instruction to the functional unit 22 for execution, and decrements its instruction execution credit 108 to 1. Similarly, at time interval 15, both operands for the add instruction of the RSS 130 are now available. Thus, the RSS 130 provides its add instruction to the functional unit 22 for execution, and decrements its instruction execution credit 108 to 1. Dataflow execution of the resident instructions of the RSS 110, the RSS 112, the RSS 114, the RSS 116, the RSS 118, the RSS 120, and the RSS 130 continues on in this manner, as indicated by arrow 142.

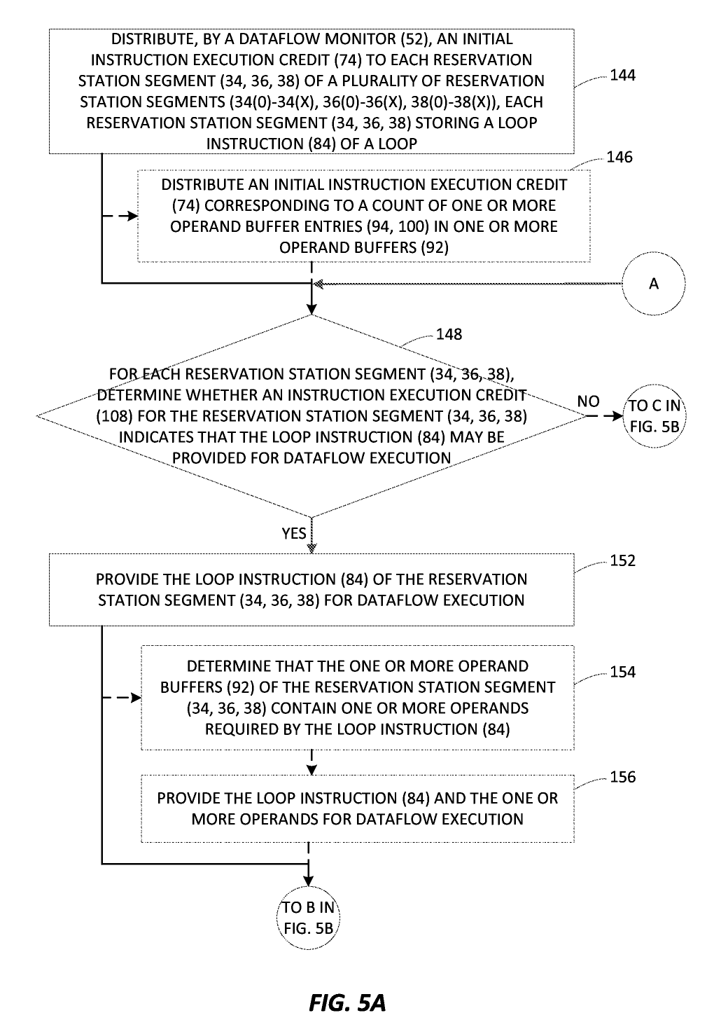

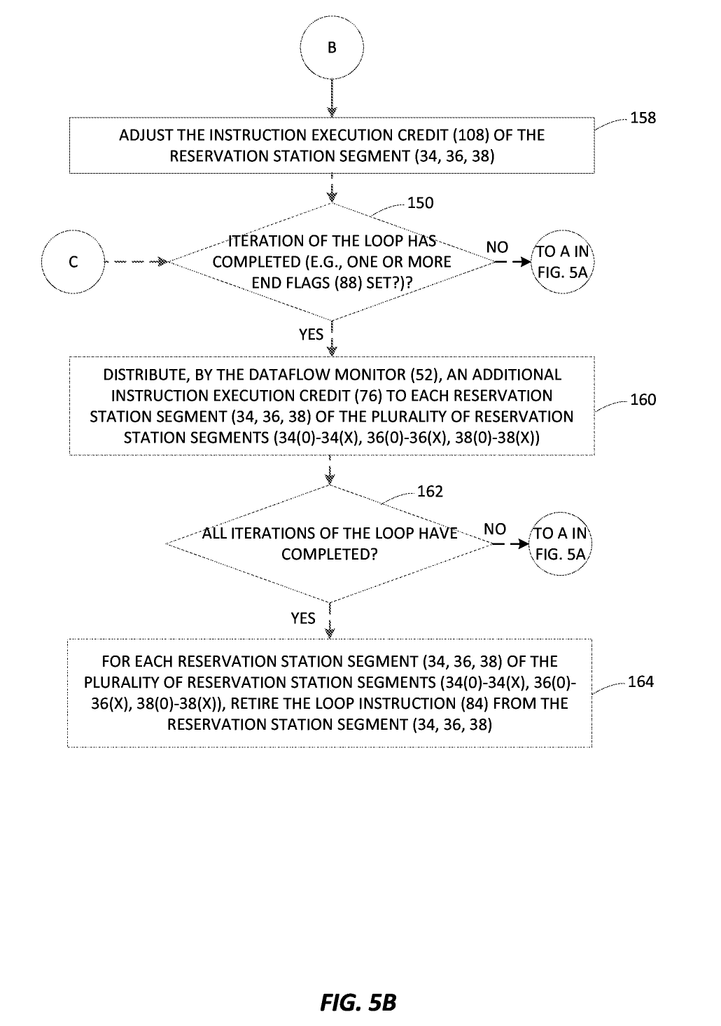

To illustrate exemplary operations for managing dataflow execution of loop instructions in the exemplary OOP 10 of FIG. 1, FIGS. 5A and 5B are provided. FIG. 5A is a flowchart that illustrates operations for distributing initial instruction execution credits and beginning iterative operations of reservation station segments. FIG. 5B shows operations for determining whether a loop iteration has completed and whether the loop itself has completed. For the sake of clarity, elements of FIGS. 1 and 2 are referenced in describing FIGS. 5A and 5B.

In FIG. 5A, operations begin with the dataflow monitor 52 distributing an initial instruction execution credit 74 to each reservation station segment 34, 36, 38 of a plurality of reservation station segments 34(0)-34(X), 36(0)-36(X), and 38(0)-38(X), respectively (block 144). As discussed above, each reservation station segment 34, 36, 38 stores a loop instruction 84 of a loop. In some aspects, the operations of block 144 may include the dataflow monitor 52 distributing an initial instruction execution credit 74 corresponding to a count of the one or more operand buffer entries 94, 100 in the one or more operand buffers 92 (block 146). For example, if each operand buffer 92(0) and 92(1) includes four operand buffer entries 94 and 100, respectively, the dataflow monitor 52 may distribute an initial instruction execution credit 74 having a value of four (4).

Each reservation station segment 34, 36, 38 then determines whether the instruction execution credit 108 for each reservation station segment 34, 36, 38 indicates that the loop instruction 84 may be provided for dataflow execution (block 148). If the instruction execution credit 108 indicates that the loop instruction 84 may not be provided for dataflow execution, processing may continue at block 150 of FIG. 5B. However, if the reservation station segment 34, 36, 38 determines at block 148 that the instruction execution credit 108 indicates that the loop instruction 84 may be provided for dataflow execution, the reservation station segment 34, 36, 38 provides the loop instruction 84 of the reservation station segment 34, 36, 38 for dataflow execution (block 152). In some aspects, the operations of block 152 may include the reservation station segment 34, 36, 38 determining that the one or more operand buffers 92 of the reservation station segment 34, 36, 38 contain one or more operands required by the loop instruction 84 (block 154). The reservation station segment 34, 36, 38 may then provide the loop instruction 84 and the one or more operands for dataflow execution (block 156). Processing then continues at block 158 of FIG. 5B.

Referring now to FIG. 5B, the reservation station segment 34, 36, 38 adjusts the instruction execution credit 108 of the reservation station segment 34, 36, 38 (block 158). The dataflow monitor 52 may then determine whether a current iteration of the loop has completed (block 150). As a non-limiting example, in some aspects the dataflow monitor 52 may determine whether one or more end flags 88 for one or more reservation station segments 36 are set. If the dataflow monitor 52 determines at block 150 that a current iteration of the loop is not complete, processing may resume at block 148 of FIG. 5A. However, if the dataflow monitor 52 determines at block 150 that an iteration of the loop has completed, the dataflow monitor 52 may distribute an additional instruction execution credit 76 to each reservation station segment 34, 36, 38 of the plurality of reservation station segments 34(0)-34(X), 36(0)-36(X), and 38(0)-38(X), respectively (block 160).

The dataflow monitor 52 may then determine whether all iterations of the loop have completed (block 162). In some aspects, the dataflow monitor 52 may maintain a count of completed iterations, and may compare the count of completed iterations with a count of total loop iterations to be executed. If the dataflow monitor 52 determines at block 162 that all iterations of the loop have not completed, processing may resume at block 148 of FIG. 5A. However, if the dataflow monitor 52 determines at block 162 that all iterations of the loop have completed, each reservation station segment 34, 36, 38 of the plurality of reservation station segments 34(0)-34(X), 36(0)-36(X), and 38(0)-38(X), respectively, may retire the loop instruction 84 from the reservation station segment 34, 36, 38 (block 164).

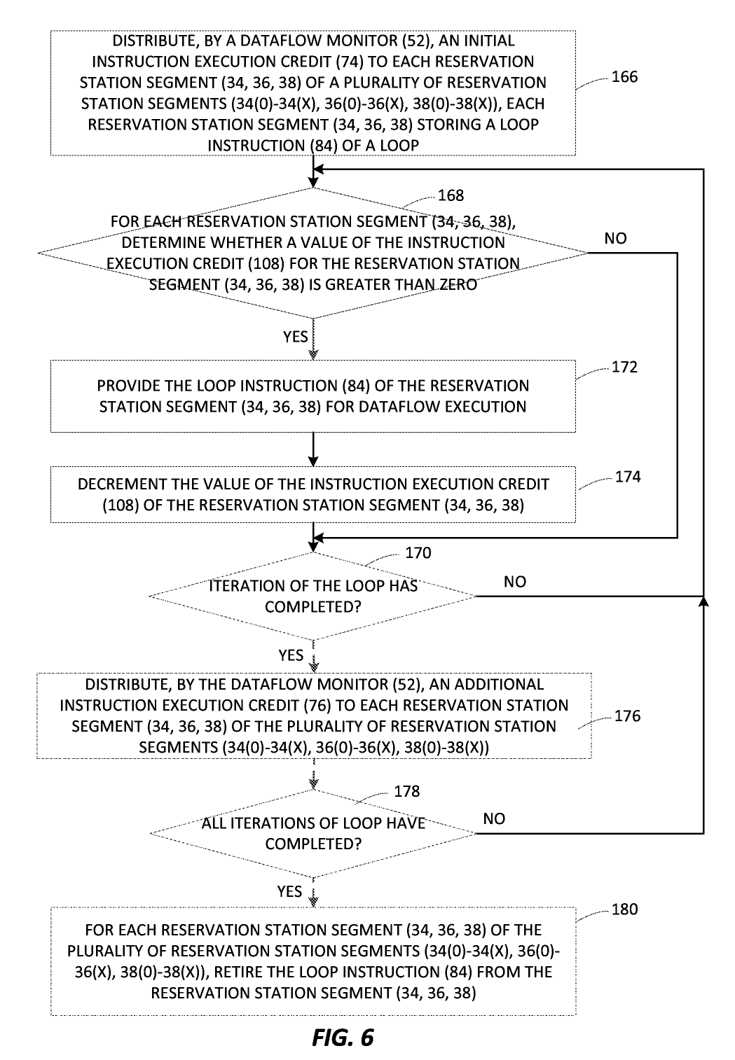

FIG. 6 is a flowchart illustrating additional exemplary operations for managing dataflow execution of loop instructions using a counter-based instruction execution credit indicator in the exemplary OOP 10 of FIG. 1. Elements of FIGS. 1 and 2 are referenced in the description of FIG. 6 for the sake of clarity. In the example of FIG. 6, operations begin with the dataflow monitor 52 distributing an initial instruction execution credit 74 to each reservation station segment 34, 36, 38 of a plurality of reservation station segments 34(0)-34(X), 36(0)-36(X), and 38(0)-38(X), respectively, each reservation station segment 34, 36, 38 storing a loop instruction 84 of a loop (block 166). In this example, the instruction execution credit indicator 106 for each reservation station segment 34, 36, 38 is a counter. Accordingly, in some aspects, the initial instruction execution credit 74 may comprise a numeric value to be stored in the instruction execution credit indicator 106 for each reservation station segment 34, 36, 38.

Each reservation station segment 34, 36, 38 then determines whether a value of the instruction execution credit 108 for the reservation station segment 34, 36, 38 is greater than zero (block 168). If the reservation station segment 34, 36, 38 determines at block 168 that the value of the instruction execution credit 108 is zero, then processing continues at block 170. However, if the reservation station segment 34, 36, 38 determines at block 168 that the value of the instruction execution credit 108 is greater than zero, the reservation station segment 34, 36, 38 provides the loop instruction 84 of the reservation station segment 34, 36, 38 for dataflow execution (block 172). The reservation station segment 34, 36, 38 also decrements the value of the instruction execution credit 108 of the reservation station segment 34, 36, 38 (block 174).

The dataflow monitor 52 may then determine whether a current iteration of the loop has completed (e.g., by determining whether one or more end flags 88 are set) (block 170). If the dataflow monitor 52 determines at block 170 that a current iteration of the loop is not complete, processing may resume at block 168. However, if the dataflow monitor 52 determines at block 170 that an iteration of the loop has completed, the dataflow monitor 52 may distribute an additional instruction execution credit 76 to each reservation station segment 34, 36, 38 of the plurality of reservation station segments 34(0)-34(X), 36(0)-36(X), and 38(0)-38(X), respectively (block 176).

The dataflow monitor 52 may then determine whether all iterations of the loop have completed (block 178). Some aspects may provide that the dataflow monitor 52 may maintain a count of completed iterations, and may compare the count of completed iterations with a count of total loop iterations to be executed. If the dataflow monitor 52 determines at block 178 that all iterations of the loop have not completed, processing may resume at block 168. However, if the dataflow monitor 52 determines at block 178 that all iterations of the loop have completed, each reservation station segment 34, 36, 38 of the plurality of reservation station segments 34(0)-34(X), 36(0)-36(X), and 38(0)-38(X), respectively, may retire the loop instruction 84 from the reservation station segment 34, 36, 38 (block 180).

Managing dataflow execution of loop instructions by OOPs, and related circuits, methods, and computer-readable media, according to aspects disclosed herein may be provided in or integrated into any processor-based device. Examples, without limitation, include a set top box, an entertainment unit, a navigation device, a communications device, a fixed location data unit, a mobile location data unit, a mobile phone, a cellular phone, a computer, a portable computer, a desktop computer, a personal digital assistant (PDA), a monitor, a computer monitor, a television, a tuner, a radio, a satellite radio, a music player, a digital music player, a portable music player, a digital video player, a video player, a digital video disc (DVD) player, and a portable digital video player.

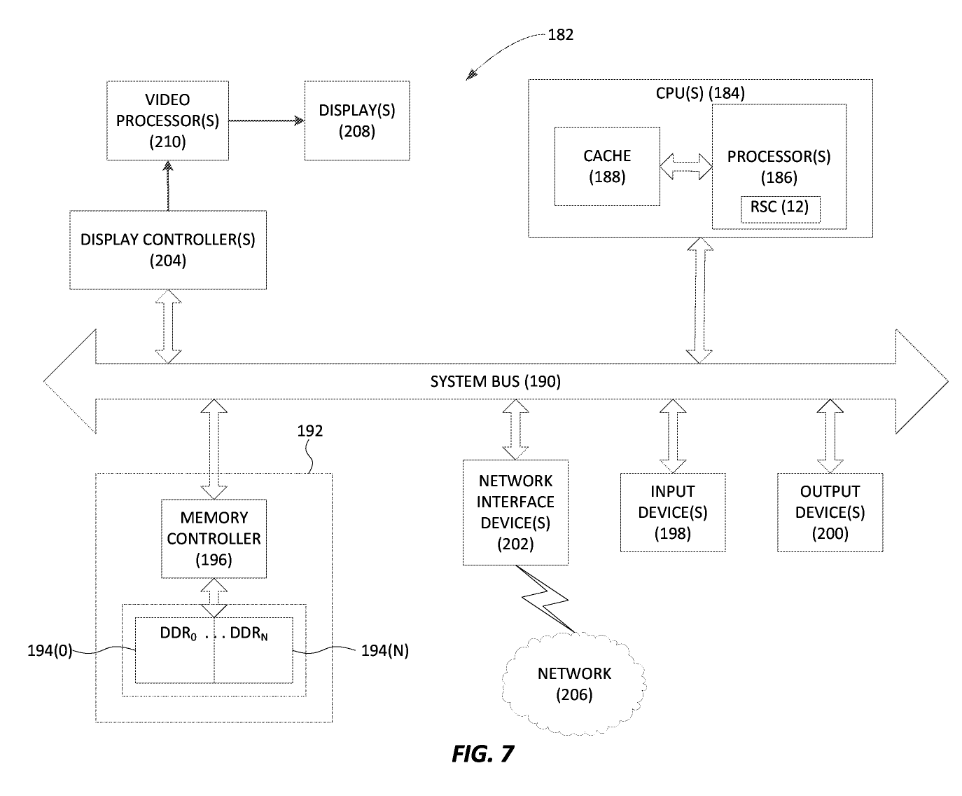

In this regard, FIG. 7 illustrates an example of a processor-based system 182 that can employ the reservation station circuit 12 illustrated in FIG. 1. In this example, the processor-based system 182 includes one or more central processing units (CPUs) 184, each including one or more processors 186 that may comprise the reservation station circuit (RSC) 12 of FIG. 1. The CPU(s) 184 may have cache memory 188 coupled to the processor(s) 186 for rapid access to temporarily stored data. The CPU(s) 184 is coupled to a system bus 190 and can intercouple master and slave devices included in the processor-based system 182. As is well known, the CPU(s) 184 communicates with these other devices by exchanging address, control, and data information over the system bus 190. For example, the CPU(s) 184 can communicate bus transaction requests to a memory system 192, which provides memory units 194(0)-194(N).

Other master and slave devices can be connected to the system bus 190. As illustrated in FIG. 7, these devices can include a memory controller 196, one or more input devices 198, one or more output devices 200, one or more network interface devices 202, and one or more display controllers 204, as examples. The input device(s) 198 can include any type of input device, including but not limited to input keys, switches, voice processors, etc. The output device(s) 200 can include any type of output device, including but not limited to audio, video, other visual indicators, etc. The network interface device(s) 202 can be any devices configured to allow exchange of data to and from a network 206. The network 206 can be any type of network, including but not limited to a wired or wireless network, a private or public network, a local area network (LAN), a wide local area network (WLAN), and the Internet. The network interface device(s) 202 can be configured to support any type of communications protocol desired.

The CPU(s) 184 may also be configured to access the display controller(s) 204 over the system bus 190 to control information sent to one or more displays 208. The display controller(s) 204 sends information to the display(s) 208 to be displayed via one or more video processors 210, which process the information to be displayed into a format suitable for the display(s) 208. The display(s) 208 can include any type of display, including but not limited to a cathode ray tube (CRT), a liquid crystal display (LCD), a plasma display, etc.

Those of skill in the art will further appreciate that the various illustrative logical blocks, modules, circuits, and algorithms described in connection with the aspects disclosed herein may be implemented as electronic hardware, instructions stored in memory or in another computer-readable medium and executed by a processor or other processing device, or combinations of both. The master and slave devices described herein may be employed in any circuit, hardware component, integrated circuit (IC), or IC chip, as examples. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends upon the particular application, design choices, and/or design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The aspects disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer-readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary aspects herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary aspects may be combined. It is to be understood that the operational steps illustrated in the flow chart diagrams may be subject to numerous different modifications as will be readily apparent to one of skill in the art. Those of skill in the art will also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but is to be accorded the widest scope consistent with the principles and novel features disclosed herein.

What is claimed is:

1. A reservation station circuit for managing dataflow execution of loop instructions in an out-of-order processor (OOP), comprising:
a plurality of reservation station segments each comprising a loop instruction register configured to store a loop instruction of a loop, and an instruction execution credit indicator configured to store an instruction execution credit indicating whether the loop instruction may be provided for dataflow execution; and
a dataflow monitor configured to distribute an initial instruction execution credit to the instruction execution credit indicator of each reservation station segment of the plurality of reservation station segments;
each reservation station segment of the plurality of reservation station segments configured to repeatedly:
determine whether the instruction execution credit of the instruction execution credit indicator for the reservation station segment indicates that the loop instruction may be provided for dataflow execution; and
responsive to determining that the instruction execution credit indicates that the loop instruction may be provided for dataflow execution:
provide the loop instruction of the reservation station segment for dataflow execution; and
adjust the instruction execution credit of the instruction execution credit indicator for the reservation station segment.

2. The reservation station circuit of claim 1, wherein:
the instruction execution credit indicator of each reservation station segment of the plurality of reservation station segments comprises a counter;
each reservation station segment of the plurality of reservation station segments is configured to:
determine whether the instruction execution credit indicates that the loop instruction may be provided for dataflow execution by determining whether a value of the instruction execution credit indicator is greater than zero; and
adjust the instruction execution credit by decrementing the value of the instruction execution credit indicator.

3. The reservation station circuit of claim 1, wherein:
each reservation station segment of the plurality of reservation station segments further comprises one or more operand buffers, each operand buffer corresponding to an operand of the loop instruction and comprising one or more operand buffer entries; and
the reservation station segment is configured to provide the loop instruction of the reservation station segment for dataflow execution by:
determining that the one or more operand buffers of the reservation station segment contains one or more operands required by the loop instruction; and
providing the loop instruction and the one or more operands for dataflow execution.

4. The reservation station circuit of claim 3, wherein the dataflow monitor is configured to distribute the initial instruction execution credit corresponding to a count of the one or more operand buffer entries in the one or more operand buffers.

5. The reservation station circuit of claim 1, wherein the dataflow monitor is further configured to:
determine whether an iteration of the loop has completed; and
responsive to determining that the iteration of the loop has completed, distribute an additional instruction execution credit to the instruction execution credit indicator of each reservation station segment of the plurality of reservation station segments.

6. The reservation station circuit of claim 5, wherein:
each reservation station segment of the plurality of reservation station segments further comprises an end flag;
the dataflow monitor is configured to determine whether the iteration of the loop has completed by detecting that one or more end flags of a corresponding one or more reservation station segments of the plurality of reservation station segments is set.

7. The reservation station circuit of claim 1 integrated into an integrated circuit.

8. The reservation station circuit of claim 1 integrated into a device selected from the group consisting of a set top box, an entertainment unit, a navigation device, a communications device, a fixed location data unit, a mobile location data unit, a mobile phone, a cellular phone, a computer, a portable computer, a desktop computer, a personal digital assistant (PDA), a monitor, a computer monitor, a television, a tuner, a radio, a satellite radio, a music player, a digital music player, a portable music player, a digital video player, a video player, a digital video disc (DVD) player, and a portable digital video player.

9. A method for managing dataflow execution of loop instructions in an out-of-order processor (OOP), comprising:
distributing, by a dataflow monitor, an initial instruction execution credit to each reservation station segment of a plurality of reservation station segments, each reservation station segment storing a loop instruction of a loop and an instruction execution credit indicator; and
for each reservation station segment of the plurality of reservation station segments, repeatedly:
determining whether an instruction execution credit for the reservation station segment indicates that the loop instruction may be provided for dataflow execution; and
responsive to determining that the instruction execution credit indicates that the loop instruction may be provided for dataflow execution:
providing the loop instruction of the reservation station segment for dataflow execution; and
adjusting the instruction execution credit of the reservation station segment.

10. The method of claim 9, wherein:
the instruction execution credit indicator of each reservation station segment of the plurality of reservation station segments comprises a counter;
determining whether the instruction execution credit indicates that the loop instruction may be provided for dataflow execution comprises determining whether a value of the instruction execution credit indicator is greater than zero; and
adjusting the instruction execution credit comprises decrementing the value of the instruction execution credit indicator.

11. The method of claim 9, wherein:
each reservation station segment of the plurality of reservation station segments further comprises one or more operand buffers, each operand buffer corresponding to an operand of the loop instruction and comprising one or more operand buffer entries; and
providing the loop instruction of the reservation station segment for dataflow execution comprises:
determining that the one or more operand buffers of the reservation station segment contains one or more operands required by the loop instruction; and
providing the loop instruction and the one or more operands for dataflow execution.

12. The method of claim 11, wherein distributing the initial instruction execution credit comprises distributing the initial instruction execution credit corresponding to a count of the one or more operand buffer entries in the one or more operand buffers.

13. The method of claim 9, further comprising:
determining, by the dataflow monitor, whether an iteration of the loop has completed; and
responsive to determining that the iteration of the loop has completed, distributing an additional instruction execution credit to each reservation station segment of the plurality of reservation station segments.

14. The method of claim 13, wherein:
each reservation station segment of the plurality of reservation station segments further comprises an end flag; and
determining, by the dataflow monitor, whether the iteration of the loop has completed comprises detecting that one or more end flags of a corresponding one or more reservation station segments of the plurality of reservation station segments is set.

15. A non-transitory computer-readable medium having stored thereon computer-executable instructions to cause a processor to implement a method for managing dataflow execution of loop instructions in an out-of-order processor (OOP), comprising:
distributing, by a dataflow monitor, an initial instruction execution credit to each reservation station segment of a plurality of reservation station segments, each reservation station segment storing a loop instruction of a loop; and
for each reservation station segment of the plurality of reservation station segments, repeatedly:
determining whether an instruction execution credit for the reservation station segment indicates that the loop instruction may be provided for dataflow execution; and
responsive to determining that the instruction execution credit indicates that the loop instruction may be provided for dataflow execution:
providing the loop instruction of the reservation station segment for dataflow execution; and
adjusting the instruction execution credit of the reservation station segment.

16. The non-transitory computer-readable medium of claim 15 having stored thereon the computer-executable instructions to cause the processor to implement the method, wherein:
each reservation station segment of the plurality of reservation station segments comprises a counter;
determining whether the instruction execution credit indicates that the loop instruction may be provided for dataflow execution comprises determining whether a value of the counter of the reservation station segment is greater than zero; and
adjusting the instruction execution credit comprises decrementing the value of the counter.

17. The non-transitory computer-readable medium of claim 15 having stored thereon the computer-executable instructions to cause the processor to implement the method, wherein:
each reservation station segment of the plurality of reservation station segments further comprises one or more operand buffers, each operand buffer corresponding to an operand of the loop instruction and comprising one or more operand buffer entries; and
providing the loop instruction of the reservation station segment for dataflow execution comprises:
determining that the one or more operand buffers of the reservation station segment contains one or more operands required by the loop instruction; and
providing the loop instruction and the one or more operands for dataflow execution.

18. The non-transitory computer-readable medium of claim 17 having stored thereon the computer-executable instructions to cause the processor to implement the method, wherein distributing the initial instruction execution credit comprises distributing the initial instruction execution credit corresponding to a count of the one or more operand buffer entries in the one or more operand buffers.

19. The non-transitory computer-readable medium of claim 15 having stored thereon the computer-executable instructions to cause the processor to implement the method, further comprising:
determining, by the dataflow monitor, whether an iteration of the loop has completed; and
responsive to determining that the iteration of the loop has completed, distributing an additional instruction execution credit to each reservation station segment of the plurality of reservation station segments.

20. The non-transitory computer-readable medium of claim 19 having stored thereon the computer-executable instructions to cause the processor to implement the method, wherein:
each reservation station segment of the plurality of reservation station segments further comprises an end flag; and
determining, by the dataflow monitor, whether the iteration of the loop has completed comprises detecting that one or more end flags of a corresponding one or more reservation station segments of the plurality of reservation station segments is set.
